(19) United States
(12) Patent Application Publication
(10) Pub. No.: US 2012/0261342 A1
(43) Pub. Date: Oct. 18, 2012

(54) PROCESS FOR IMPROVING THE PRECIPITATION OF CALCIUM AND/OR MAGNESIUM SALTS IN THE REGENERATION OF USED ALKALINE CLEANING SOLUTION

(76) Inventor: Gilles TASTAYRE, Ridgeway (CA)

(21) Appl. No.: 13/534,651

(22) Filed: Jun. 27, 2012

Related U.S. Application Data
(63) Continuation-in-part of application No. 12/328,794, filed on Dec. 5, 2008.

(51) Int. Cl. B08B 3/14; B01D 37/02; B01D 33/27; B01D 21/01; B01D 61/14

(52) U.S. Cl. 210/650; 210/728; 210/721

(57) ABSTRACT

A process for improving the precipitation of calcium and/or magnesium salts in the regeneration of a used alkaline cleaning solution includes the steps of providing a spent alkaline or acidic cleaning solution, adding sodium bentonite and sodium carbonate to the spent alkaline or acidic cleaning solution in a mixing zone so as to provide an interactive solution, adding only one of an anionic polymeric flocculating agent or a cationic polymer flocculating agent to the interactive solution, and precipitating in soluble calcium and magnesium salts as flocs. The solution containing the flocs is subjected to a filtration process so as to bring the precipitated solids to a solids content of greater than 25%.

### RELATED U.S. APPLICATIONS

The present application is a continuation-in-part of U.S. application Ser. No. 12/328,794, filed on Dec. 5, 2008 and entitled “Regeneration of Used Cleaning Solution”, presently pending.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the improvement of the precipitation of calcium and magnesium in the regeneration of used alkaline or acidic cleaning solution. Additionally, the present invention relates to such a process in which anionic or cationic polymeric flocculating agents are added to a mixture of the cleaning solution, sodium bentonite and sodium carbonate. Additionally, the present invention relates to the precipitation of calcium and/or magnesium salts from such used alkaline or acidic cleaning solutions in which the precipitated solids have a solids content of greater than 25%.

2. Description of Related Art Including Information Disclosed Under 37 CFR 1.97 and 37 CFR 1.98.

It is known to clean and clarify water by adding one or more coagulating agents to water to combine fine particles therein into flocs and to thereby sediment the flocs by gravity. In this known method, water is separated into a floc phase and an aqueous phase. The separated flocs are removed from the treating vessel and are dewatered and the solids discarded. The separated water can then be returned to a water source.

It is also well-known that metal ions dissolved in water can be removed by the addition of various treatment agents which react with the metal ions and precipitate as insoluble salts. This is of use in the treatment of contaminated water when, for example, the addition of calcium hydroxide (i.e. lime) to the hard water will cause the precipitation of metal carbonates so as to remove the metal and bicarbonate ions from the water. This precipitation process can be further improved by the addition to the water of a polyelectrolyte which promotes the flocculation of the solid particles and a weighting agent (e.g., calcium carbonate) which increases the specific gravity of the flocculated matter and therefore increases the rate of sedimentation and thus the rate of clarification of the liquor.

It is also known to remove suspended solid materials from water by the addition of coagulants, e.g., aluminum sulfate, iron chloride, etc. These are normally employed, along with lime, in conjunction with sedimentation and/or filtration procedures. The coagulants assist the building of a floc to a proper size for settling. Sedimentation units permit the separation of the relatively slow-settling floc thus formed from the purified water.

Various patents have issued relating to the process of purifying solutions. For example, British Patent No. 2,095,226, describes a composition for use in the purification of water. This composition contains an alkaline earth metal hydroxide and an anionic oligomeric polyelectrolyte. The composition can also contain a weighting agent and a cationic polyelectrolyte.

British Patent No. 2,157,278 describes a method of treating water using a composition containing calcium sulphate as a weighting agent, an electrolyte having a multivalent cation (e.g., iron (III) or aluminum), and a cationic or anionic polyelectrolyte.

Canadian Patent No. 2,006,512, issued on Dec. 22, 1989 to A. Timmons, provides a method for the purification of contaminated water. The treatment involves the application of anionic and cationic coagulants to the water at different stages. Precipitation agents are added to precipitate the contaminants. The coagulants were polyelectrolytes. The first added coagulant causes formation of a floc. The addition of the second coagulant causes heavy deposition of contaminants. The next step is separation such that the separated solids are passed to a sludge thickening tank. The separated liquids could be filtered to provide clean water so as to be returned to a stream or river.

Canadian Patent No. 2,012,201 issued on Mar. 14, 1990 to S. D. Kamato et al, provides a method for treating water which includes adding a first chemical containing an alkali metal or alkaline earth metal oxide or hydroxide to the water to be treated. This renders muddy water alkaline. A second chemical, containing an anionic polymer coagulant, was added to the water, either simultaneously with, or after, the addition of the first chemical. A third chemical containing a sulfate was the added so as to render the water weakly alkaline. Finally, a fourth chemical containing an anionic polymer coagulant was added to the muddy water. As a result, large-sized and hard flocs were produced. When the water is in the weakly alkaline state, an anionic polymer coagulant is added to the muddy water to cause the remaining fine particles, the hydroxide, and the metal ions to be combined. This results in larger-sized and harder flocs.

U.S. Pat. No. 5,510,037, issued Apr. 23, 1996 to the present inventor, provides a process for regenerating spent cleaning solutions. The process involves the steps of first preconditioning the spent solution. An absorbent material is added to the preconditioned solution to provide an interactive solution. Suitable precipitation agents are added to the interactive solutions to precipitate undesirable materials from the solutions. The precipitating of the undesirable materials from the interactive solution is accomplished by adding an anionic and a cationic polymeric flocculating agent thereto. Specifically, the flocculating agents are added to the interactive solution to provide a reactive solution. The reactive solution is then thoroughly mixed. The other anionic or cationic flocculating solution is then added so as to precipitating insoluble salts as flocs. Finally, the solution containing the precipitated flocs is subjected to a solid/liquid separation.

The process of cleaning is a rather a complex technology whose efficacy is governed by the following parameters: (1) time; (2) temperature; (3) concentration; and (4) shear. Some cleaning solutions contain detergents to remove soils and/or compounded alkalis and caustics to react upon organic residues. Other such cleaning solutions may contain acids to remove inorganics and minerals.

It is an object of the present invention to provide a process that regenerates and recycles spent alkaline and acidic cleaning solution.

It is an object of the present invention to provide a process that maintains alkaline cleaning solutions at peak efficiency.

It is another object of the present invention to provide a process that significantly reduces chemical, organic, and BOD/COD pollution.

It is further object of the present invention to provide a process that saves on chemical usage, water usage and energy.

It is a further object of the present invention to provide a process that reduces cleaning time in order increase overall productivity.

It is still a further object of the present invention to provide a process which decreases or eliminates the need for wastewater treatment facilities.

These and other objects and advantages of the present invention will become apparent from a reading of the attached specification and appended claims.

### BRIEF SUMMARY OF THE INVENTION

The present invention is a process for improving the precipitation of calcium and/or magnesium salts in the regeneration of a used alkaline or acidic cleaning solutions. This process includes the steps of: (1) adding a thoroughly-mixed aqueous slurry of sodium bentonite and sodium carbonate to the spent alkaline or acidic cleaning solution in order to provide an interactive solution; (2) adding only one of an anionic polymeric flocculating agent and a cationic polymer flocculating agent to the interactive solution; (3) precipitating insoluble calcium and magnesium salts as flocs so as to simultaneous provide a reactive solution; and (4) filtering the reactive solution so as to bring the precipitated solids to a solids content of greater than 25%.

The precipitation of insoluble calcium and magnesium salts in flocs is carried out cyclically. The step of filtrating is carried out continuously. The continuous filtration is achieved by providing a balance zone for the cyclically-produced alkaline or acidic cleaning solution which has been treated.

In the preferred embodiment of the present invention the flocculating agent is a single cationic polymer flocculating agent. In particular, this cationic polymer flocculating agent is either a polyamide or polyacrylate.

In an alternative embodiment of the present invention, the flocculating agent is a single anionic polymeric coagulant which is selected from the group of alginic acid, alginates, sodium polyacrylate, maleate, copolymers, and partial hydrolyzates ofpolyacrylamide, anionic polyacids and salts thereof, and alkaline metal salts of a simple or complex oligomer of acrylic or methacrylic acid, a low-viscosity sodium carbosimethole celluous and oligomeric sulphanate.

In the step of precipitating, the selected coagulant is added to the interactive solution. This solution is then thorough mixed in a mixing zone.

The step of filtrating is carried out using one of carbon sand, filter sand, a membrane, and a rotor vacuum filter with an appropriate precoat. The filtrating is in the range of 1 to 10 microns. When a rotary vacuum filter is used, the precoat is selected from the group consisting of diatomaceous silica, perlite, siliceous material, carbon, and fibrous cellulose.

The process further can include the step of ultrafiltering the filtered solution from 5,000 to 15,000 Daltons. The filtering can also include the step of oxidizing. When oxidizing is used, the oxidizing can employ the use of ozone, hydrogen peroxide, or other appropriate chemical oxidizers.

The process of the present invention is relatively simple to operate. It provides effective flocculation of solid calcium and/or magnesium salts which are precipitated when chemical treatment agents are added to the solution. The result of the process is the production of large-size and hard flocs which are formed through the use of a small amount chemicals. This process for regenerating spend alkaline and acidic cleaning solution avoids the reaction of any dispersed residues with the caustics. As such, cleaning efficiency will be improved. The available active caustic concentration remains higher with less top-over required to maintain the concentration. The process of the present invention keeps the soil load at a low level so that the cleaning solution are more active and clean faster. Organic soil, which has low heat transmittance that tends to foul surfaces, is removed so that the regenerated solution can be heated with using less energy and without fouling surfaces. The process of the present invention treats soiled solutions so as to remove the soil so that the regenerated solutions flow better and penetrate more efficiently.

### BRIEF DESCRIPTION OF THE SEVERAL VIEWS OF THE DRAWINGS

FIG. 1 is a flow diagram of the regeneration system for the process of the present invention.

### DETAILED DESCRIPTION OF THE INVENTION

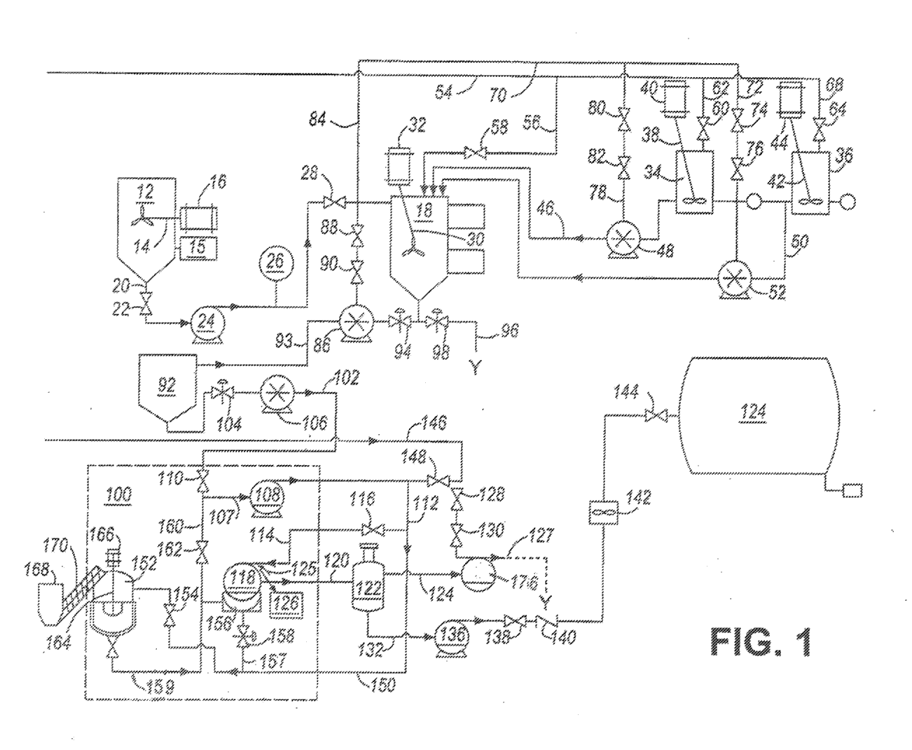

Referring to FIG. 1, the regeneration system includes a spent cleaning solution holding tank 12, which is equipped with a stirrer 14, driven by motor 16. Holding tank 12 is provided with level controller 15 to determine the volume of liquid in holding tank 12. Holding tank 12 is connected to mixing tank 18 by way of inflow feed line 20 from the bottom of holding tank 12 which is provided with manual outflow control valve 22, pump 24, which is controlled by a flow switch 26, and inflow air valve 28 to inflow feed line 20 feeding to the top of mixing tank 18. Flow switch 26 controls the operation of pump 24 to stop the operation of pump 24 if there is no liquid in the holding tank 12 and hence in pump 24. The mixing tank 18 is equipped with a stirrer 30 which is driven by motor 32.

The mixing tank 18 is connected to a primary reagent tank 34 and to a secondary reagent tank 36, which are equipped with a primary stirrer 38 which is driven by primary motor 40, and a secondary stirrer 42 which is driven by secondary motor 44, respectively. In between primary reagent tank 34 and mixing tank 18 is by way of primary feed line 46 extending from near the bottom of primary reagent tank 34 to the top of mixing tank 18, a slurry of the primary reagent being pumped by pump 48.

The connection between primary reagent tank 34 and mixing tank 18 is by way of primary feed line 46 extending from near the bottom of primary reagent tank 34 to the top of mixing tank 18, a slurry of the primary reagent being pumped by pump 48. The connection between secondary reagent tank 36 and mixing tank 18 is by way of secondary feed line 50 extending from near the bottom of secondary reagent tank 36 to the top of mixing tank 18, a solution or slurry of the secondary reagent being pumped by pump 52.

The mixing tank 18 is also connected to a first water line 54, via a branch water line 56, which is equipped with a solenoid valve 58 in the branch water line 56 leading to top of the mixing tank 18. The first water line 54 is also provided with a first water pressure regulator valve 60 near the end of a first water pressure line 62 and a second water pressure regulator valve 64 near the end of a second water pressure line 68. First water pressure regulator valve 60 controls the amount of water admitted into primary reagent tank 34 through first water pressure line 62 to be mixed with the first reagent to provide a first reagent slurry. Second water pressure regulator valve 64 controls the amount of water admitted into secondary reagent tank through second water pressure line 68 to be mixed with the second reagent to provide a second reagent solution or slurry.

An air line 70 also is connected as follows: via a first air branch line 72 to pump 52, via suitable valves, namely, solenoid valve 74 and air control valve 76; via a second air branch line 78 to pump 48 via suitable valves, namely solenoid valve 80 and air control valve 82; and via a third air branch line 84 to pump 86 via suitable valves, namely, solenoid valve 88 and air control valve 90. The air control vales 76, 82 and 90 control the respective solenoid valves 74, 80 and 88 to operate the respective pumps 52, 48 and 86.

The mixing tank 18 is connected to a balance tank 92, by withdrawal line 94 which is connected between the bottom of mixing tank 18 and the top of balance tank 92, by way of valve 94 and pump 86. Balance tank 92 is provided to assure continuous flow to the suitable filter system (to be described later) even though the operation of the mixer to provide the precipitate is cyclical. A drain line 96 from the bottom of mixing tank 18 is also controlled by valve 98.

The balance tank 92 is connected to a suitable filter system, in this embodiment being a rotary vacuum filter system 100. The connection between balance tank 92 and the filter system is by way of a first flow line 102 from the bottom of balance tank 92 via air valve 104 and pump 106, then by a second flow line 106 to pump 108 via manual valve 110, then by a third flow line 117 and fourth flow line 114 via manual valve 116 to the inlet side of rotary vacuum filter 118.

Rotary vacuum filter 118 includes a first outlet line 120 which is connected to the inlet of defoamer 122, via vacuum connecting line 124, and a doctor blade to scrape solids to an outlet sludge bin 126. The vacuum connecting line 124 from defoamer 122 is connected to a vacuum pump 126 which exhausts via exhaust line 127. Inlet air to vacuum pump 126 via manual valves 128, 130. DeFoarner 122 also includes a major outlet line 132 connected between the bottom of defoamer 122 and the inlet of a major tank 124, via a pump 136, and suitable valves, namely, manual valve 138, check valve 140, flow meter 142 and manual valve 144.

A precoat storage tank 168 is connected to the top of mix tank 152 via upwardly-slanting screw conveyor 170. Mix tank 152 includes a water inlet line 150 connected to third flow line 112, water inlet line 150 leading into mix tank 152 via manual valve 154. Precoat material from precoat sludge tank 168 which is fed into mix tank 152 via slanting screw conveyor 170 is mixed to a slurry by means of the added water, and mixer 164 rotated by motor 166.

A slurry withdrawal line 159 leads, via manual valve 160 and line 106 to pump 108 and thence via lines 112 and 114 to the top of rotary vacuum filter 118. This forms a filter cake on the rotary vacuum filter 118. Excess slurry is withdrawn via line 157 and manual valve 158 to be recycled to the mix tank 152 via line 150 and manual valve 154.

In use, after the alkaline or acidic cleaning solution is used in a cleaning step, such cleaning solution results in a spent alkaline or spent acidic cleaning solution to be regenerated. The regeneration according to the present invention will now be described.

The spent alkaline or acidic cleaning solution is thoroughly mixed in the spent alkaline or acidic cleaning solution holding tank and is pumped into the mixing tank. The primary reagent tank holds an aqueous slurry of bentonite and sodium carbonate. It is thoroughly mixed and is pumped into the mixing tank. The secondary reagent tank holds an aqueous solution and/or slurry of a flocculating agent, i.e., one of an anionic coagulant and a cationic coagulant. It is thoroughly mixed and is pumped into the mixing tank.

The thorough mixing in the mixing tank of the added reagents to the spent alkaline or acidic cleaning solution improves the precipitation of the calcium and/or magnesium salts.

The thoroughly-mixed precipitated solution from the mixing tank is pumped into the balance tank. The balance tank is never empty so that the filtration process can continue continuously while the spent alkaline or acidic cleaning solution is being cyclically mixed with the bentonite, sodium carbonate and the flocculating agent. Then, the solution with the precipitates therein is pumped to a rotary vacuum filter system. The rotary vacuum filter has previously been provided with a filter aid coating thereon. The solids are scraped off by a doctor blade and deposited to a sludge bin. The withdrawn liquid is defoamed in a defoamer and is pumped to a holding tank for regenerated cleaning solution to be fortified by others.

A preferred sodium bentonite which is used is the Wyoming or Black Hills type of swelling bentonite. This type of bentonite is composed almost entirely of particles of moutinorillonite that expand or swell greatly when dispersed in water.

The Wyoming or Black Hills type bentonite is in the form of colloidal particles which are typically hydrophilic in character. That is, each particles is hydrated or solvated, and made bulky and loose-textured by firmly bound water which penetrates between, and expands greatly, the lattice sheets making up each unit of a bentonite particle. The bound water also forms a thick seat which encloses each unit.

Sodium bentonite possesses the following characteristics which relate more specifically to the practice of the present invention. When suspended in water which contains unsubstantial quantities of electrolytes or ionizable substances, sodium bentonite swells to as much as thirty times its original volume to form a gelatinous paste which, upon. further dilution with water, if need, can be dispersed by stirring to form a colloidal solution. In this solution, the disperse phase comprises negatively charged, highly hydrated bentonite particles of the type hereinabove described. In the absence of some suitable flocculating agent such a solution will show no separation of the disperse phase for an indefinite period of time due to the mutual repulsion of the outer, cationic portion of the cations being carried by the “bound” water surrounding each bentonite particle. If, however, an electrolyte, or ionizable material capable of furnishing cations, is added in suitable proportion to such a bentonite solution, there ensues a sufficient neutralization of the anions, the anions being carried by the bentonite particles themselves, and concomitant reduction in their mutual repulsion, so that groups of the particles coalesce to form aggregates of varying sizes. In the case of a majority of the bentonite particles, this aggregation extends until there is a rapid formation of visible flocs. The sodium bentonite must be used in conjunction with sodium carbonate to precipitate excess magnesium and/or calcium ions.

Importantly, in the present invention, only a single polymeric flocculating agent is used in the sodium bentonite modified dispersion. The dissolving of the sodium carbonate in the sodium bentonite in a separate step unexpectedly activates the sodium bentonite. This allows the use of only a single flocculating polymer.

In particular, tests were conducted to determine the impact of sodium carbonate as a additive to bentonite dispersion. There was an improvement in its dispersing ability and handling of the bentonite slurry, as well as an improvement of the regenerative process, by the use of only a single polymer. In particular, a 100 ml sample was subjective to a regenerative process involving absorption/flocculation with sodium bentonite and a selection of polymers. The following table shows the result of test involving such a process:

TABLE I

| | Sample set | | | |
|---|---|---|---|---|
| | 1 | 2 | 3 | 4 |
| Spent caustic solution | 100 ml | 100 ml | 100 ml | 100 ml |
| 5% bentonite dispersion | 1 ml | 1 ml | | 1 ml |
| 5% sodium bentonite | | | 1 ml | |
| modified dispersion (a) | | | | |
| anionic polymer 0.2% | 1 ml | 1 ml | | |
| cationic polymer 0.2% | 1 ml | | 1 ml | 1 ml |
| Average NFU (8 tests) | 22 | 137 | 21.2 | 147 |
| Average COD | 2445 | 2514 | 1054 | 2472 |

In the above table, the sample set “1” was a regenerative process involving absorption/flocculation with sodium bentonite and two polymers. Sample set “2” was subjected to the regenerative process involving absorption/flocculation with only a single anionic polymer. Sample set “3” was subjected to the regenerative process involving absorption/flocculation with only a single cationic polymer. Finally, sample set “4” was subjected to the regenerative process involving absorption/flocculation with only the cationic polymer but using the same sodium bentonite dispersed in a 1% sodium carbonate solution. Each sample was allowed to cool and settle for a period of four (4) hours. The floc was evaluated for density and cohesion. Supernatant samples of each test were then analyze for turbidity and COD according to the parameters normally used when regenerating caustic solutions. The set of experiments was conducted eight times and average readings were calculated.

As can be seen on the above Table I, the addition of sodium carbonate to the bentonite dispersion provided as the same good results as the use of two different polymers. On the COD reduction analysis, it was notice that there was a much-reduced residual COD when compared to the use of two polymers. This indicates an activation of the bentonite through the dispersion in the presence of sodium carbonate. As such, this tables show the unexpected results when using only a single polymer. The preferred result is the use of a single cationic polymer, as shown in sample set “3”. As such, the present invention provides significant improvement over the prior art.

It should be noted that the cationic coagulant can be a polyamide or a polyacrylate. If the anionic polymer (shown in sample set “2”) is anionic polymer, such an anionic polymer can be alginic acid, alginates, sodium polyacrylate, maleate, copolymers, and partial hydrolyzates of polyacrylamide, anionic polyacids and salts thereof, alkaline metal salts of a simple or complex oligomer of acrylic or methacrylic acid, a low-viscosity sodium carboxymethyl celluous and oligomeric sulphanate. In a neutral or acid solution, chitosan may be used.

In carry out the step of precipitating, the selective coagulant is added to the interactive solution. The solution is then thoroughly mixed. The final solids/liquids separation step is achieved by filtering. This filtering can use carbon sand, a membrane, or a stainless steel membrane. Conventional filter sand may also be used. The preferred technique is the use of a rotary vacuum filter with an appropriate precoat thereon. The filtration will be in the range of one to ten microns. Various other filtration techniques can be provided as long as the proper solid content is obtained. At this concentration, the residue may be disposed of as regular solid waste. No specific disposal method is required.

The process can also include the step of ultrafiltering of the filtered solution as a final step. This serves to further increase the clarity of the treated solution and insure substantially complete removal of any potential micro-organisms therein. The ultrafiltration can be done at 5,000 to 15,000 Daltons through the use of appropriate membranes.

The filtration steps can further include the oxidization step. Ozone, hydrogen peroxides, or other appropriate chemical oxidizers may be added to complete the oxidation of any further impurities in the solution.

The filtering can be achieved through structures containing much coarser sand so as to act as straining devices (otherwise known as “rapid sand filters”). It should be noted that filters have little inherent clarifying capacity in themselves. The basis for clarification has been provided by the prior treatment appropriate chemicals as described hereinabove. In other words, the suspended matter therein is treated to collect sufficiently large agglomerates so as to settle out and be substantially removed by primary filtration in advance of any secondary filtration. The process can also include absorption by means of active agents by the flocculating polymer, setting in sedimentation basin to remove the agglomerates, and finally the primary filter which takes out the larger-sized contaminants.

In order to prevent clogging of the openings and the eventual slowing down or complete stopping of the flow liquids through the filter, a small amount of filter aid may be added to the liquid to be filtered. In order to increase the initial efficiency of the filtering process, a pre-coat of filter aid particles may be provided on the filter, in addition to the incorporation of particles within the liquid to be filtered. The materials most generally used as filter aids include diatomaceous silica, perlite, siliceous material, carbon, and fibrous matter (e.g. cellulose). Other filter aids involve the step of preconditioning the filter feed by adding thereto small amounts of powdered active magnesium oxide and pulverulent filter aids, as earlier described, preferably in a pre-filtered tank having mild agitation and nominal retention. It can then be filtered by a standard type of filter aid filtering technique.

The foregoing disclosure and description of the invention is illustrative and explanatory thereof. Various changes in the details of the described steps can be made within the scope of the appended claims without departing from the true spirit of the invention. The present invention should only be limited by the following claims and their legal equivalents.

I claim:

1. A process for improving precipitation of calcium and/or magnesium salts in the regeneration of a used alkaline or acidic cleaning solution, the processing comprising:
adding a thoroughly-mixed aqueous slurry of sodium bentonite and sodium carbonate to the cleaning solution to provide an interactive solution;
adding only one of an anionic polymeric flocculating agent and a cationic polymer flocculating agent to said interactive solution;
precipitating in the flocculating agent-added interactive solution soluble calcium and magnesium salts as flocs and simultaneously providing a reactive solution; and
subjecting the reactive solution containing the flocs to a filtration process so as to bring the precipitated solids to a solids content of greater than 25%.

2. The process of claim 1, the precipitation in insoluble calcium and magnesium salts being carried out cyclically, the filtration process being carried out continuously.

3. The process of claim 2, the continuous filtration having a balance zone or the cyclically-produced alkaline or acidic cleaning solution.

4. The process of claim 1, wherein the flocculating agent is a cationic polymer flocculating agent.

5. The process of claim 4, said flocculating agent being a polyamide.

6. The process of claim 4, said flocculating agent being a polyacrylate.

7. The process of claim 4, said flocculating agent being an anionic polymer coagulant selected from the group consisting of alginic acid, alginates, sodium polyacrylate, maleate, copolymers, and partial hydrolyzates of polyacrylamide, anionic polyacids and salts thereof, and alkaline metal salts of a simple or complex oligomer of acrylic or methacrylic acid, a low-viscosity sodium carboxymethyl celluous and oligomeric sulphanate.

8. The process of claim 1, the step of precipitating comprising:
adding a coagulate to the interactive solution; and
mixing the interactive solution in a mixing zone.

9. The process of claim 1, the filtration process being carried out using one of carbon sand, filter sand, a membrane, and a rotor vacuum filter having a precoat.

10. The process of claim 9, the filtration process filtering in the range of 1 to 10 microns.

11. The process of claim 7, said filtration process using a rotary vacuum filter having a precoat, said precoat selected from the group of diatomaceous silica, perlite, siliceous material, carbon, and fibrous cellulose.

12. The process of claim 1, further comprising the step of ultrafiltering the filtered solution at 5,000 to 15,000 Daltons.

13. The process of claim 1, the step of filtering comprising oxidizing.

14. The process of claim 13, the step of oxidizing comprising the use of ozone or hydrogen peroxides.

15. The process of claim 1, said anionic polymeric flocculating agent being a single cationic polymer flocculating agent.
